(19) United States
(12) Patent Application Publication
(10) Pub. No.: US 2024/0086732 A1
(43) Pub. Date: Mar. 14, 2024

(54) KNOWLEDGE GRAPH CONSTRUCTION METHOD AND SYSTEM

(71) Applicant: Alipay (Hangzhou) Information Technology Co., Ltd., Hangzhou (CN)

(72) Inventors: Lei Liang, Hangzhou (CN); Feng Qiu, Hangzhou (CN)

(21) Appl. No.: 18/243,558

(22) Filed: Sep. 7, 2023

(30) Foreign Application Priority Data
Sep. 9, 2022 (CN) 202211105858.5

(51) Int. Cl. G06N 5/022

(52) U.S. Cl. CPC G06N 5/022

(57) ABSTRACT

Some embodiments of this specification disclose a knowledge graph construction method and system. The method includes: obtaining ontology definition data of a knowledge graph, where the ontology definition data includes node definition data of a plurality of nodes, the node definition data includes a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and processing instance data based on the ontology definition data to obtain the knowledge graph that includes a node instance of a standard type attribute value and/or a concept type attribute value.

### CROSS-REFERENCE TO RELATED APPLICATIONS

This application claims priority to and the benefit of Chinese Application No. 202211105858.5 filed on Sep. 9, 2022, the contents of which are incorporated herein by reference in their entirety.

### TECHNICAL FIELD

This specification relates to the big data processing field, and in particular, to a knowledge graph construction method and system.

### BACKGROUND

A knowledge graph is a semantic network graph that includes nodes and edges, and is usually used to perform knowledge modeling in big data scenarios. Currently, mainstream graph structures used for knowledge modeling include attribute graphs or semantic graphs. However, the two graph structures are both limited during industrial big data processing. To improve efficiency of big data knowledge modeling, some embodiments of this specification provide an attribute graph knowledge modeling method and system for semantic enhancement, so as to ensure a normative structure of a knowledge graph while improving a semantic representation capability of the knowledge graph, thereby meeting a more complex data requirement.

### SUMMARY

Some embodiments of this specification provide a knowledge graph construction method, including: obtaining ontology definition data of a knowledge graph, where the ontology definition data includes node definition data of a plurality of nodes, the node definition data includes a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and processing instance data based on the ontology definition data to obtain the knowledge graph that includes a node instance of a standard type attribute value and/or a concept type attribute value.

Some embodiments of this specification provide a knowledge graph construction system, including: a first obtaining module, configured to obtain ontology definition data of a knowledge graph, where the ontology definition data includes node definition data of a plurality of nodes, the node definition data includes a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and a first processing module, configured to process instance data based on the ontology definition data to obtain the knowledge graph that includes a node instance of a standard type attribute value and/or a concept type attribute value.

Some embodiments of this specification provide an apparatus, including a processor and a storage medium, where the storage medium stores a computer instruction, and the processor is configured to execute the computer instruction to implement the foregoing knowledge graph construction method.

Some embodiments of this specification provide a storage medium, configured to store a knowledge graph, where the knowledge graph includes a node instance of a standard type attribute value and/or a concept type attribute value, a standard type is used to represent a fixed format of an attribute value, and a concept type is used to represent a multi-level structure of the attribute value.

### BRIEF DESCRIPTION OF DRAWINGS

This specification is further described by using some example embodiments, and these example embodiments are described in detail with reference to the accompanying drawings. These embodiments are not restrictive. In these embodiments, the same number represents the same structure. In the accompanying drawings:

FIG. 1 is an example attribute graph according to some embodiments of this specification;

FIG. 2 is an example semantic graph according to some embodiments of this specification;

FIG. 3 is an example flowchart of a knowledge graph construction method according to some embodiments of this specification;

FIG. 4 is an example knowledge graph according to some embodiments of this specification; and

FIG. 5 is a module diagram of a knowledge graph construction system according to some embodiments of this specification.

### DESCRIPTION OF EMBODIMENTS

To describe the technical solutions in some embodiments of this specification more clearly, the following briefly describes the accompanying drawings needed for describing the embodiments. Clearly, the accompanying drawings in the following descriptions merely illustrate some examples or embodiments of this specification, and a person of ordinary skill in the art can still apply this specification to other similar scenarios based on these accompanying drawings without creative efforts. Unless apparent from the language environment or otherwise stated, the same reference numeral in the figures represents the same structure or operation.

It should be understood that the “system”, “apparatus”, “unit”, and/or “module” used in this specification are used to distinguish different components, elements, parts, portions, or assemblies of different levels. However, if other words can achieve the same purpose, other expressions can be used to replace the words used in this specification.

As described in this specification, unless otherwise the context explicitly indicates an exception, the words “a/an”, “one”, and/or “the” do not necessarily indicate a singular form, and may include a plural form. Generally, the terms “comprise” and “include” indicate only an inclusion of steps and elements that have been explicitly identified, and these steps and elements do not constitute an exclusive enumeration, and the method or the device may further include other steps or elements.

A flowchart is used in this specification to describe an operation performed by a system according to some embodiments of this specification. It should be understood that the preceding or subsequent operations are not necessarily performed accurately in a sequence. Instead, the steps can be processed in reverse order or simultaneously. In addition, other operations may be added to these processes, or one or more operations may be removed from these processes.

A knowledge graph is a semantic network graph that includes nodes and edges. The node can describe object information, and the edge can express an association between objects, which is consistent with knowledge logic in most scenarios. Therefore, the knowledge graph is usually used to perform knowledge modeling in big data scenarios, so as to represent knowledge information visually and concisely.

In some application scenarios, the knowledge graph may also be briefly referred to as a graph. The knowledge graph is widely used in such technical fields as physics, chemistry, biology, medical treatment, transportation, communication, and the Internet. A node in the graph represents an object. The node may have a plurality of types, which are referred to as node types and are used to indicate various objects. Specifically, the objects may be a user, a merchant, an account, a city, a concept, a drug, a company, a device, a phenomenon, an event, an attribute, etc. An edge in the graph represents a relationship between objects. The edge may also have a plurality of types, which are referred to as edge types and are used to represent various relationships. For example, Zhang San and Li Si are friends, social accounts and mobile terminals have a login relationship, and an account A transfers funds to account B. For ease of description, a node representing an “XX” object may be briefly referred to as an “XX node”, and an edge representing an “XX” relationship may be briefly referred to as an “XX edge”. When no ambiguity is caused, objects and nodes can be used interchangeably, and relationships and edges can also be used interchangeably.

In some specific application scenarios, there may be knowledge graphs with different architectures or different knowledge expression focuses, such as an attribute graph and a semantic graph.

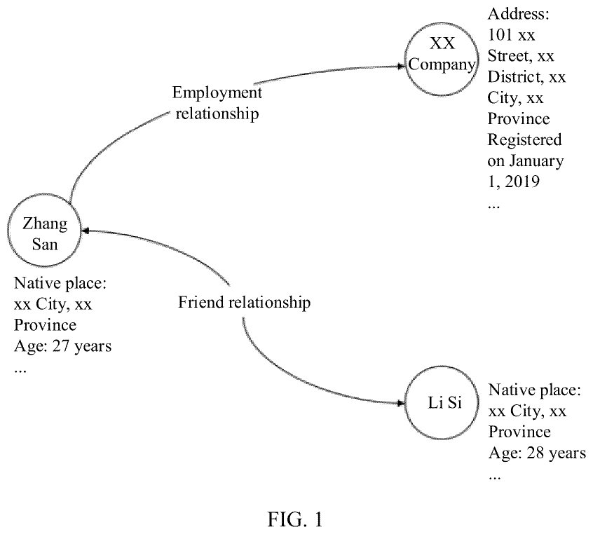

The attribute graph is a graph structure that emphasizes normalization and structure standardization. A node in the attribute graph corresponds to an entity, and normalized attribute data is set on the node. Optionally, normalized attribute data may also be set on an edge. The entity is a thing that exists objectively in the real world. For example, a node corresponding to the entity can be used to represent a person, a company, a device, a merchant, an account, or the like. The attribute data of the node is used to describe in detail the entity corresponding to the node. A person node is used as an example. Attribute data of the person node may include an age, a gender, a native place, a taste preference, and the like. The attribute data of the edge is used to describe a relationship between corresponding entities. A company node and a person node are used as an example. A relationship between the company node and the person node may be employment. The attribute data of the edge may include internship, long-term employment, external employment, and the like. In the attribute graph, attribute data of a node or an edge generally has a standard data format, and these data formats are basic types, such as int (integer type), float (single-precision floating-point type), double (double-precision floating-point type), and string (string type). FIG. 1 is an example attribute graph according to some embodiments of this specification. The attribute graph includes a node of a corresponding person (for example, Zhang San or Li Si) and a node of a corresponding company (for example, xx Company). Each node has its attribute data, and there is an edge between nodes. A type of the edge includes a friend relationship and an employment relationship.

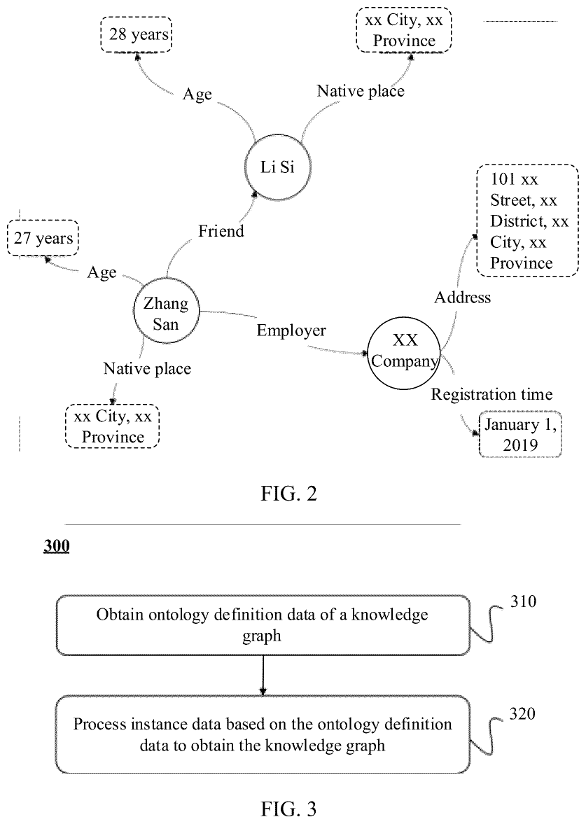

The semantic graph is a graph structure that emphasizes a semantic representation capability, and uses a subject-predicate-object (SPO) triple as a basic semantic unit. The node in the semantic graph corresponds to a subject (S) or an object (O), and may be specifically an entity or may correspond to a concept. The edge between nodes corresponds to a predicate (P). A concept is also referred to as abstract knowledge, and is knowledge obtained by abstracting and summarizing a common essential characteristic of a perceived thing by human being in a cognition process. Such knowledge includes, for example, a gender, an address represented by using an administrative division, and a cuisine obtained by summarizing dishes. In some embodiments, it may be considered that attributes of an entity may be classified as conceptual categories. FIG. 2 is an example semantic graph according to some embodiments of this specification. In the graph, a circular node is a subject node, which is mostly an entity; a square node is an object node, which may be an entity or a concept. An edge in the graph corresponds to a predicate (P). For example, in the graph, “xx Company”—“Address”—“101 xx Street, xx District, xx City, xx Province” form one SPO triple representing the semantics of xx Company's address at 101 xx Street, xx District, xx City, xx Province. It can be seen that each graph element triple (node-edge-node) in the semantic graph corresponds to the SPO triple, and has rich semantics.

It may be understood from comparison between FIG. 1 and FIG. 2 that, the attribute graph has an efficient and standardized structure, but directly expresses relatively weak semantics; the semantic graph has a flexible structure that aims to express the SPO triple, but directly expresses rich semantics, leading to an excessively complex structure definition and exposing problems during multi-element and spatial-temporal knowledge expression. However, in most enterprise-class application scenarios of big data, with accumulation of knowledge data, there are a demand for quickly constructing a knowledge graph based on knowledge data and a demand for standardized knowledge precipitation. In view of the foregoing description, some embodiments of this specification provide a set of more friendly knowledge modeling frameworks that are applicable to industrial big data scenarios. Semantic enhancement is performed on the basis of an attribute graph, thereby ensuring a normative structure of a knowledge graph while improving a semantic representation capability of the knowledge graph.

Before some embodiments of this specification are described in detail, another basic concept of the knowledge graph, namely, ontology definition data (schema), is described first. Generally, the knowledge graph refers to a knowledge base that includes a series of instance data (including node instances and relationship instances between node instances). The ontology definition data of the knowledge graph is data that defines nodes included in the knowledge graph and relationships between nodes. The ontology definition data can efficiently and abstractly describe knowledge logic reflected by instance data in the knowledge graph, and is used to guide the collection of instance data and construct a graph based on the instance data to obtain a knowledge graph (which may also be referred to as an instance graph or a data graph). Specifically, the ontology definition data of the knowledge graph may include definition data used for a node, where the definition data of the node may be represented in a field form, the node field may be understood as a node name, for example, the node field may be “company” or “user”, and a value of the node field may be instance data of the node, or may be briefly referred to as a node instance, for example, “Zhang San” or “xx Company”. The node field may correspond to a plurality of attribute fields. The attribute field may be an abstraction of the node description information. For example, the attribute field may be “address”, “age”, or “registered capital”. A value of the attribute field may be a specific description of a node instance corresponding to the attribute field, for example, “11 Jianshe Road”, “28 years”, or “5 million”. In some embodiments, the ontology definition data of the knowledge graph may further include definition data of an edge that is used to define a relationship between nodes, and the definition data of the edge may be represented as a relationship description. The relationship description may be an abstraction of a type of the relationship between nodes, such as “employment relationship”, “parent-subsidiary company relationship”, and “friend relationship”. In some embodiments, the relationship description may further include a relationship attribute, and the relationship attribute is used to further describe the relationship description. For example, the “employment relationship” may be specifically “temporary employment” or “formal employment”, and the “parent-subsidiary company relationship” may further include “wholly-owned holding relationship”, “partially-owned holding relationship”, and the like. The relationship description can determine whether there is an edge between two node instances when the knowledge graph is constructed.

In some embodiments, a graph operator can be further determined. The graph operator is used to identify a node instance from a large amount of instance data and determine a relationship between node instances based on the node definition or the relationship description. The graph operator may also be understood as a graph computing algorithm or method, and is used to perform a data processing operation or operation for graph construction. Methods such as a data processing/operation unit, program code, and a machine learning model can be used for implementation. In some embodiments, the graph operator can perform corresponding data processing/operation on the input data of the operator, complete data conversion, and output converted data. In some embodiments, the graph operator may be considered as an algorithm or a method established on the ontology definition data (including entity definition and relationship description) of the knowledge graph, or as a part of the ontology definition data.

FIG. 3 is an example flowchart of a knowledge graph construction method according to some embodiments of this specification.

In some embodiments, a process 300 shown in FIG. 3 can be implemented by a computing device. For example, the process can be implemented by a knowledge graph construction system 500 deployed on the computing device. As shown in FIG. 3, the process 300 may include:

Step 310: Obtain ontology definition data of a knowledge graph. In some embodiments, step 310 can be implemented by a first obtaining module 510.

The ontology definition data is the basis of the knowledge graph. As described above, before the knowledge graph is generated based on the instance data, the ontology definition data of the knowledge graph needs to be constructed. To enhance semantic representation, some embodiments of this specification extend an attribute value type in the ontology definition data of the knowledge graph. To be specific, in addition to a basic type, the attribute value type additionally includes a standard type and a concept type. The basic type is used to represent a data type of an attribute value, and may be specifically a type such as int, float, double, or string. It can be seen that the basic type defines the basic data type.

In practice, a part of attribute data of a node (or attribute data of an edge) has a fixed format, such as a telephone number, an email address, and a MAC address. The data essentially includes data of the basic type. To improve efficiency of knowledge construction, some embodiments of this specification provide a standard type for such attribute data. Specifically, the standard type can be defined based on the basic type and a format description. The format description may be represented as a regular expression or another restrictive description. For example, the standard type of the telephone number can be defined as “∧(13[0-9]|14[5|7]|15[0|1|2|3|5|6|7|8|9]|18[0|1|2|3|5|6|7|8|9])\d{8}$”, and the standard type of the email address can be defined as “∧\w+([−+.]\w+)*@\w+([−.]\w+)*\.\w+([−.]\w+)*$”, or the like. In some embodiments, the basic type and the format representation can be encapsulated into a class. The class is instantiated to define the attribute data type of the node. For example, ontology definition data of a knowledge graph may include a statement “email: Email” to define a type of an email address attribute of a node, where “email” is an attribute field, and “Email” represents a data type of an email address type, and may be considered as encapsulation of “∧\w+([−+.]\w+)*@\w+([−.]\w+([−.]\w+)*\.\w+([−.]\w+)*$”.

In some other embodiments, the attribute data may further have a hierarchical structure, such as an administrative division (province—city—district), a cuisine (level-1 cuisine—level-2 cuisine—level-3 cuisine), and the like. The data still essentially includes data of the basic type, but has specific hierarchical structures, and these hierarchical structures are relatively stable. Such type of attribute data is generally obtained by people by abstracting and summarizing directly perceived knowledge. A level description is proposed for ease of management or use. Therefore, some embodiments of this specification provide a concept type for such type of attribute data. Specifically, the concept type can be defined based on the basic type and the level description. The level description may include a level quantity, a level order, and a value range of each level. The concept type of the cuisine is used as an example. The level description can be expressed as “Level-1 cuisine {Western food, Chinese food}-Level-2 cuisine {French, Italian, American, . . . , Mediterranean} {Sichuan cuisine, Guangdong cuisine, Shandong cuisine, . . . , Hunan cuisine}—Level 3 cuisine { . . . }{ . . . }, . . . , {fried dish, hot pot, barbecue}. It can be seen that the concept type of the cuisine includes three levels, which are arranged in a level order of level 1, level 2, and level 3. In the expression, content of { } is a value range of each level, and each value range enumerates the included elements. It can be seen that the concept type itself contains a large amount of knowledge content, for example, a level included in an administrative division and a lower-level value range inherent to each value range. During construction of different ontology definition data, defining the attribute data of the concept type can help reuse the knowledge, thereby improving efficiency of knowledge construction.

To further enhance semantics, some embodiments of this specification further provide a node type of an attribute graph, that is, in addition to an entity node, further include a node type of an event node. The event node corresponds to an event. An event is a thing that takes place in the real world and that has specific influence. Unlike the entity node, the event node generally includes at least two subjects. However, the entity node corresponds to a maximum of one subject (such as a company or a user). Correspondingly, the event node has at least two object attributes. The object attribute is participant information of an event, for example, may be a name of a company participating in the event and identity information of a person participating in the event. In some embodiments, an attribute value type of an object attribute can be defined as an entity type (which may be represented by using entity node definition data in the ontology definition data). An attribute value type may be an entity type, so that information about an entity node can be directly referenced to define a participant of the event, thereby efficiently reusing the knowledge to some extent. When an attribute value is an entity type, such attribute definition data can be automatically converted into relationship definition data. In some embodiments, the event node further includes a time attribute, a space attribute, and the like, and is configured to fully describe event information. The event node is introduced into the attribute graph so that an event can be represented by using a knowledge graph. As such, not only a plurality of subjects included in the event can be combined, but also time and space evolution of the event can be depicted. On the one hand, after these events are precipitated as standard events, when an identical event is encountered in subsequent construction of another knowledge graph, the existing event node data can be directly referenced, thereby improving efficiency of knowledge modeling. On the other hand, in some risk control or financial investment scenarios, a knowledge graph is used to precipitate an evolution process of risky events, for example, events of a trade war, an epidemic, and an industry chain. A development rule of these events can be discovered by using a knowledge graph. Such precipitated experience can be reused when similar events are encountered in the future.

Ontology definition data of a knowledge graph includes node definition data of a company litigation event node:

CompanyLitigationEvent (company litigation event){eventName (event name) String relatedCompany (related company) Company relatedPerson (related person) Person dateOfTheCourtSession (date of the court session) Timestamp domain (domain) AdminArea}.

Timestamp represents a type of an attribute value of a date of the court session, and belongs to a standard type. AdminArea (administrative division) represents a type of an attribute value of a domain, and belongs to a concept type. The related company attribute and the related person attribute are the foregoing object attributes. Company represents a company node in the ontology definition data, and is used to indicate that an attribute value of the related company attribute is a company entity type. Person represents a natural person node in the ontology definition data, and is used to indicate that an attribute value of the related person attribute is a natural person entity type. Correspondingly, it may be understood that there is an edge defined between the company litigation event node and the Company node, and there is an edge defined between the company litigation event node and the Person node. In some embodiments, the node definition data may further include a type identifier, which is used to indicate that the node type is an entity, an event, or a concept.

In some embodiments, the node type of the attribute graph further includes a concept node. The concept node is associated with the concept type of one of the foregoing attribute value types. Unlike the entity node and the event node, the instance data corresponding to the concept node is an element in the value range in the level description information of the concept type, and can be directly obtained based on the ontology definition data. A cuisine is used as an example. A value range in a level description of the cuisine includes “Sichuan cuisine”, “hot pot”, and “barbecue”. Correspondingly, a concept node “Sichuan cuisine”, a concept node “hot pot”, and a concept node “barbecue” can be arranged in the knowledge graph. In some embodiments, the node instances of the concept node may be in a one-to-one correspondence with the elements of value ranges in the level description of the concept type in the ontology definition data. In some embodiments, the concept node may alternatively correspond to other types of attribute data, such as an email address node. Introducing the concept node into the knowledge graph can represent attribute data as a node, and establish an edge connection between a node instance of the concept node and each of a node instance of the entity node type and a node instance of the event node type, thereby enriching semantic information of the knowledge graph and further enhancing semantic representation of the attribute graph.

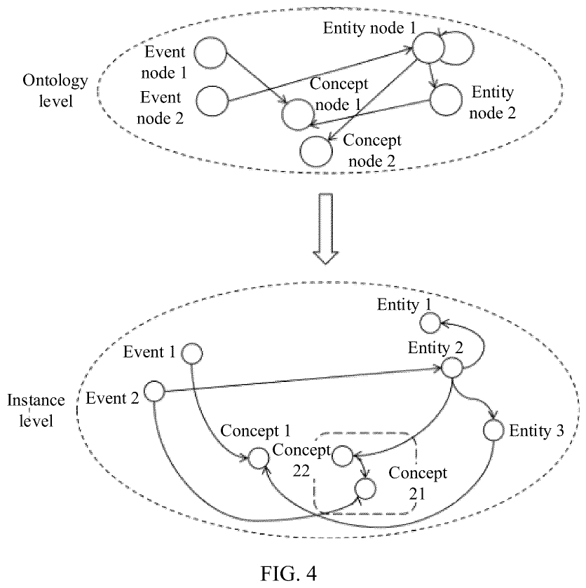

FIG. 4 shows an example of a knowledge graph and corresponding ontology definition data according to some embodiments of this specification. The ontology level in the graph is a visual presentation of the ontology definition data of the knowledge graph. In some embodiments, the ontology definition data includes node definition data of six nodes (which are nodes at the level of the ontology definition data and are not node instances, or may be referred to as node types). The event node 1 corresponds to a trade war event, the event node 2 corresponds to an epidemic event, the concept node 1 corresponds to a date, the concept node 2 corresponds to a cuisine, the entity node 1 corresponds to a person, the entity node 2 corresponds to a company, and a connection line between nodes represents edge definition data. For example, the ontology definition data defines that there is an edge connection between the event node 1 and the concept node 1. Further, an attribute field and an attribute value type can be defined for the event node and the entity node, and the attribute value type may be selected from the basic type, the standard type, and the concept type. For more descriptions of the node definition data, references can be made to the foregoing related description of the ontology definition data and the node definition data of the company litigation event node.

Step 320: Process instance data based on the ontology definition data to obtain the knowledge graph that includes a node instance. In some embodiments, step 320 can be implemented by the first processing module 520.

The ontology definition data is the definition data of the node and the edge in the knowledge graph, and is used to guide the collection and processing of the instance data in the knowledge graph. For example, the ontology definition data defines a user node, and corresponding instance data may be Zhang San, Li Si, or the like. The instance data may come from service data in various service fields, such as a product sales department and a financial service platform.

In some embodiments, a corresponding node instance can be obtained from service data of a corresponding platform or service field based on the ontology definition data of the knowledge graph, for example, the node definition data of the entity node. The node instance further includes attribute data of a corresponding node attribute field. Specifically, for a node whose type is an entity node or an event node, a corresponding node instance can be obtained from service data. For a concept node associated with the concept type, a node instance corresponding to an element in each value range can be generated directly based on the level description of the concept type in the ontology definition data. For a concept node associated with the standard type, a node instance can be generated based on related attribute values of node instances of the entity node and the event node.

In some embodiments, the ontology definition data may further include a graph operator, which further includes an attribute value standardization operator. The attribute value standardization operator is used to perform expression standardization processing on an attribute value of an attribute field obtained from the service data to conform to a type thereof. For example, the attribute value standardization operator can unify a data format of an attribute value of a telephone number attribute into a 13-digit numeric format, or select a corresponding element from a value range of each level based on the instance data, and determine an attribute value of the concept type for the corresponding node instance. For example, a territoriality attribute value of the “xx Company” node is “Sichuan Province—Chengdu City—Hi-Tech Zone”. For another example, a business scope attribute value of the Mifs store is “Chinese food—Sichuan cuisine—hot pot”.

In some embodiments, an edge instance between node instances can be further determined from the service data based on the edge definition data in the ontology definition data. For example, if the edge definition data defines that there may be a “friend relationship” between person nodes, and the service data shows that Zhang San is in a social APP of Li Si, an edge of the “friend relationship” can be established between the “Zhang San” node and the “Li Si” node based on the foregoing description.

In some embodiments, a graph operator such as a chain pointer operator is needed to establish an edge for a node instance. In some embodiments, the chain pointer operator can establish a relationship description of two node instances based on attribute values of the corresponding two node instances. The “Zhang San” node has the preference attribute “hot pot”, and the Mifs store node has the business scope attribute “Chinese food—Sichuan cuisine—hot pot”. The chain pointer operator may have a similar or same attribute value to establish an edge for two instance nodes. The edge may be a “recommendation relationship”. In some other embodiments, the chain pointer operator can establish a relationship description of two node instances based on an attribute value of one node instance and a node name of the other node. For example, the Mifs store node has the business scope attribute “Chinese food—Sichuan cuisine—hot pot”, the graph includes the concept node instance “hot pot”, and the chain pointer operator can establish an edge for two instance nodes based on similar or same attribute values and node names. The edge may be a “business scope”. For another example, the “Zhang San” node has a contact information attribute “123@163.com”, the graph includes a concept node instance “123@163.com”, and the chain pointer operator can establish an edge for two instance nodes based on similar or same attribute values and node names. The edge may be “contact information”. In some other embodiments, the chain pointer operator can establish a relationship description of two node instances based on the level description and node names of the corresponding two nodes. For example, the graph includes a concept node instance “hot pot”, a concept node instance “Sichuan cuisine”, and a concept node instance “Chinese food”. The chain pointer operator can successively establish an edge between the “hot pot” node and the “Sichuan cuisine” node, and an edge between the “Sichuan cuisine” node and the “Chinese food” node based on the level description of the cuisine. The edge may be a “belongingness relationship”.

An instance level in FIG. 4 shows a knowledge graph generated based on ontology definition data of the instance level, where the event 1 is instance data of the event node 1, for example, a “tariff increase event in March 2019”; the event 2 is instance data of the event node 2, for example, an “epidemic event on Jul. 3, 2022”; the entities 1 and 2 are instance data of the entity node 1, for example, “Zhang San” and “Li Si” respectively; the entity 3 is instance data of the entity node 2, for example, “xx Company”; the concept 1 is instance data of the concept node 1, for example, “2019”; the concepts 21 and 22 are instance data of the concept node 2, for example, “Sichuan cuisine” and “hot pot” respectively. A relationship between the event 1 and the concept 1 is “occurrence time”, a relationship between the entity 3 and the concept 1 is “establishment time”, a relationship between the event 2 and the concept 21 is “associated site business scope”, a relationship between the entity 1 and the entity 2 is “friend relationship”, a relationship between the entity 2 and the entity 3 is “employment relationship”, a relationship between the event 2 and the entity 2 is “associated subject”, a relationship between the entity 2 and the concept 22 is “taste preference”, and a relationship between the concept 22 and the concept 21 is “belongingness relationship”.

The knowledge graph that includes the node instance of the standard type attribute value and/or the concept type attribute value can be established by using a process 300. The knowledge graph may further include the concept node and the event node, thereby improving efficiency of knowledge modeling, enhancing semantic representation of the graph, and facilitating knowledge precipitation and reuse.

Some embodiments of this specification further provide a knowledge graph construction apparatus, including a processor and a storage medium, where the storage medium stores a computer instruction, and the processor is configured to process the computer instruction to implement the foregoing knowledge graph construction method.

The knowledge graph obtained by performing the process 300 can be stored in a storage medium. Therefore, some embodiments of this specification further provide a storage medium, where the storage medium stores the knowledge graph that includes the node instance of the standard type attribute value and/or the concept type attribute value and that is obtained based on the process 300.

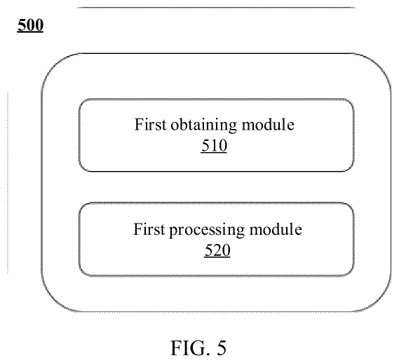

FIG. 5 is a module diagram of a knowledge graph construction system according to some embodiments of this specification.

As shown in FIG. 5, the knowledge graph construction system 500 may include a first obtaining module 510 and a first processing module 520.

The first obtaining module 510 may be configured to obtain ontology definition data of a knowledge graph, where the ontology definition data includes node definition data of a plurality of nodes, the node definition data includes a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value.

The first processing module 520 may be configured to process instance data based on the ontology definition data to obtain the knowledge graph that includes a node instance of a standard type attribute value and/or a concept type attribute value.

For more description of each module, references can be made to the related description in FIG. 3.

It should be understood that the system and its modules shown in FIG. 5 can be implemented by using various methods. For example, in some embodiments, the system and its modules can be implemented by using hardware, software, or a combination of software and hardware. The hardware part can be implemented by using dedicated logic. The software part can be stored in a memory and executed by an appropriate instruction execution system, such as a microprocessor or dedicated design hardware. A person skilled in the art may understand that the foregoing methods and systems can be implemented by using a computer-executable instruction and/or be included in processor control code for implementation. For example, such code is provided on a carrier medium such as a disk, a CD, or a DVD-ROM, on a programmable memory such as a read-only memory (firmware), or on a data carrier such as an optical or electronic signal carrier. The system and its modules in this specification can be implemented not only by a hardware circuit of a semiconductor such as a very large-scale integrated circuit or gate array, a logic chip, a transistor, or a programmable hardware device such as a field programmable gate array or a programmable logic device, but also by software executed by various types of processors, or can be implemented by a combination of the foregoing hardware circuit and software (for example, firmware).

It should be noted that the foregoing descriptions of the system and its modules are for ease of description only, and this specification should not be limited to the scope of the enumerated embodiments. It may be understood that, a person skilled in the art can, after understanding the principle of the system, randomly combine the modules, or form a subsystem and connect the subsystem to another module without departing from the principle. For example, the first processing module 520 can be split into two or more submodules.

Beneficial effects that may be brought by some embodiments of this specification include but are not limited to: (1) The knowledge graph construction method provided in this specification introduces concept modeling by using a concept type or a concept node of an attribute value, so that a node instance can be combined with industry or common knowledge, thereby implementing precipitation and efficient reuse of common knowledge in the field. (2) The node type of the event node is introduced so that an event can be represented by using a graph. As such, not only a plurality of entities included in the event can be combined, but also time and space evolution of the event can be depicted. (3) The node type of the concept node is introduced so that an association between the event node/entity node and the abstract knowledge, and a level relationship between concept nodes can be visually represented at the graph level, thereby efficiently extending the semantics of the attribute graph, and facilitating more sufficient and refined knowledge mining. It should be noted that beneficial effects that may be brought by different embodiments are different. In different embodiments, a beneficial effect that may be brought may be any one or a combination of the foregoing beneficial effects, or may be any other beneficial effect that may be obtained.

The basic concepts have been described above. Clearly, for a person skilled in the art, the foregoing detailed disclosure is merely an example, and does not constitute a limitation on some embodiments of this specification. Although not expressly stated herein, a person skilled in the art may make various modifications, improvements, and amendments to some embodiments of this specification. Such modifications, improvements, and amendments are recommended in some embodiments of this specification. Therefore, such modifications, improvements, and amendments still fall within the spirit and scope of some example embodiments of this specification.

In addition, specific words are used in this specification to describe some embodiments of this specification. For example, “one embodiment”, “an embodiment”, and/or “some embodiments” mean a feature, structure, or characteristic related to at least one embodiment of this specification. Therefore, it should be emphasized and noted that, “an embodiment”, “one embodiment”, or “one alternative embodiment” mentioned twice or more times at different locations in this specification does not necessarily refer to the same embodiment. In addition, some features, structures, or characteristics in one or more embodiments of this specification can be appropriately combined.

In addition, a person skilled in the art may understand that aspects of some embodiments of this specification may be explained and described based on some patentable types or conditions, including a combination of any new and useful processes, machines, products, or substances, or any new and useful improvements to the processes, machines, products, or substances. Correspondingly, aspects of some embodiments of this specification can be executed by hardware only, can be executed by software (including firmware, resident software, microcode, and the like) only, or can be executed by a combination of hardware and software. The foregoing hardware or software may be referred to as a “data block”, “module”, “engine”, “unit”, “component”, or “system”. In addition, aspects of some embodiments of this specification may be represented as a computer product located in one or more computer-readable media, and the product includes computer-readable program code.

The computer storage medium may include a propagated data signal that includes computer program code, for example, on a baseband or as a part of a carrier. The propagated signal may have a plurality of representation forms, including an electromagnetic form, an optical form, or the like, or an appropriate combination form. The computer storage medium may be any computer-readable medium other than a computer-readable storage medium. The medium can be connected to an instruction execution system, apparatus, or device to implement communication, propagation, or transmission of a program for use. Program code located on a computer storage medium can be propagated through any appropriate medium, including radio, a cable, a fiber optic cable, RF, or a like medium, or any combination thereof.

The computer program code needed for each part of the operation in some embodiments of this specification can be written in any one or more programming languages, including object-oriented programming languages such as Java, Scala, Smalltalk, Eiffel, JADE, Emerald, C++, C #, VB.NET, Python, etc., conventional programming languages such as C, Visual Basic, Fortran2003, Perl, COBOL2002, PHP, ABAP, dynamic programming languages such as Python, Ruby, and Groovy, or other programming languages. The program code can be run entirely on a user computer, or run as an independent software package on a user computer, or run partially on a user computer and partially on a remote computer, or run entirely on a remote computer or a processing device. In the latter case, the remote computer can be connected to the user computer in any form of a network, such as a local area network (LAN) or a wide area network (WAN), or connected to an external computer (e.g., through the Internet), or in a cloud computing environment, or used as a service, such as software as a service (SaaS).

In addition, unless expressly stated in the claims, the sequence of the processing elements and sequences, the use of numerals or letters, or the use of other names in some embodiments of this specification are not intended to limit the sequence of the processes and methods in some embodiments of this specification. Although some inventive embodiments that are currently considered useful have been discussed in various examples in the foregoing disclosure, it should be understood that, such details are for illustrative purposes only, and the appended claims are not limited to the disclosed embodiments. On the contrary, the claims are intended to cover all amendments and equivalent combinations that conform to the essence and scope of some embodiments of this specification. For example, although the system components described above can be implemented by hardware devices, they can be implemented only by software solutions. For example, the described system is installed on existing processing devices or mobile devices.

Similarly, it should be noted that, to simplify the description disclosed in some embodiments of this specification and thereby help understand one or more embodiments of this specification, the foregoing descriptions of some embodiments of this specification sometimes incorporate a plurality of features into one embodiment, accompanying drawing, or descriptions thereof. However, such disclosure method does not mean that features needed by an object in some embodiments of this specification are more than the features mentioned in the claims. In fact, the features of embodiments are less than all the features of a single embodiment disclosed above.

Each patent, patent application, patent application publication and other materials referenced in this specification, such as articles, books, instructions, publications, and documents, are all incorporated in this specification by reference in their entireties. Except for the application history documents that are inconsistent with or conflict with the content of this specification, documents (currently or subsequently appended to this specification) that impose a limitation on the widest scope of the claims of this specification are also excluded. It should be noted that if the description, definition, and/or use of a term in the materials attached to this specification are inconsistent with or conflict with the content of this specification, the description, definition, and/or use of a term in this specification shall prevail.

Finally, it should be understood that some embodiments described in this specification are merely intended to describe the principles of the embodiments of this specification. Other variations may also fall within the scope of some embodiments of this specification. Therefore, by way of example and not limitation, alternative configurations of some embodiments of this specification may be considered to be consistent with the teachings of this specification. Correspondingly, the embodiments of this specification are not limited to some embodiments specifically explained and described in this specification.

What is claimed is:

1. A knowledge graph construction method, comprising:
obtaining ontology definition data of a knowledge graph, wherein the ontology definition data comprises node definition data of a plurality of nodes, the node definition data comprises a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and
processing instance data based on the ontology definition data to obtain the knowledge graph that comprises a node instance of a standard type attribute value and/or a concept type attribute value.

2. The method according to claim 1, wherein the standard type is defined based on the basic type and a format description, and the concept type is defined based on the basic type and a level description.

3. The method according to claim 2, wherein the level description comprises a level quantity, a level order, and a value range of each level.

4. The method according to claim 1, wherein the node definition data further comprises a node type, the node type is an entity node, an event node, or a concept node, the entity node corresponds to an objectively existing thing, the event node corresponds to an event, and the concept node corresponds to abstract knowledge.

5. The method according to claim 4, wherein a node whose node type is the event node comprises a time attribute and two or more object attributes, the object attribute comprises participant information of an event, and an attribute value type of the object attribute is represented by using definition data of the entity node in the ontology definition data.

6. The method according to claim 3, wherein the processing instance data based on the ontology definition data comprises:
determining a node instance corresponding to a node whose node type is an entity node and/or an event node from the instance data based on the node definition data in the ontology definition data; and
a node instance corresponding to a node whose node type is a concept node has a mapping relationship with an element of a value range in the level description.

7. The method according to claim 6, wherein the processing instance data based on the ontology definition data further comprises:
processing an attribute value and/or a node name of a node instance by using a chain pointer operator, and further establishing an edge instance between node instances.

8. The method according to claim 7, wherein the ontology definition data further comprises edge definition data of an edge between nodes, and the edge instance is instance data corresponding to an edge in the ontology definition data.

9. An apparatus comprising a memory and a processor, wherein the memory stores executable instructions that, in response to execution by the processor, cause the apparatus to:
obtain ontology definition data of a knowledge graph, wherein the ontology definition data comprises node definition data of a plurality of nodes, the node definition data comprises a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and
process instance data based on the ontology definition data to obtain the knowledge graph that comprises a node instance of a standard type attribute value and/or a concept type attribute value.

10. A non-transitory computer-readable storage medium having stored therein instructions that, when executed by a processor of a device, cause the device to:
obtain ontology definition data of a knowledge graph, wherein the ontology definition data comprises node definition data of a plurality of nodes, the node definition data comprises a node attribute value type, the node attribute value type is a basic type, a standard type, or a concept type, the basic type is used to represent a data type of an attribute value, the standard type is used to represent a fixed format of the attribute value, and the concept type is used to represent a multi-level structure of the attribute value; and
process instance data based on the ontology definition data to obtain the knowledge graph that comprises a node instance of a standard type attribute value and/or a concept type attribute value.
